(19) United States
(12) Patent Application Publication
(10) Pub. No.: US 2018/0217245 A1
(43) Pub. Date: Aug. 2, 2018

(54) DETECTING ABRUPT DECELERATION USING DOPPLER EFFECT OF SIGNAL CHANGE

(71) Applicant: GM Global Technology Operations LLC, Detroit, MI (US)

(72) Inventors: Eilon Riess, Zikron-Yaakov (IL); Tal Philosof, Givatayim (IL)

(21) Appl. No.: 15/418,886

(22) Filed: Jan. 30, 2017

(51) Int. Cl. G01S 11/10; H04W 4/04; H04W 4/22

(52) U.S. Cl. CPC G01S 11/10; H04W 4/22; H04W 4/046

(57) ABSTRACT

Examples of techniques for detecting abrupt deceleration of a vehicle using Doppler change of a received signal are disclosed. In one example implementation according to aspects of the present disclosure, a computer-implemented method may include establishing, by a processing device, a radio link between a transceiver in the vehicle and a remote transceiver. The method may further include continuously calculating, by the processing device, a Doppler of the received signal. The method may further include detecting, by the processing device, a change in the Doppler of the received signal. The method may further include determining, by the processing device, whether the change in the Doppler of the received signal is indicative of an abrupt deceleration.

### INTRODUCTION

The present disclosure relates to detecting abrupt deceleration of a vehicle using Doppler Effect of a received signal.

A vehicle, such a car, motorcycle, a boat, or any other type of automobile may be equipped with communications devices (e.g., a cellular transceiver, a dedicated short-range communications (DSRC) transceiver, a Wi-Fi transceiver, etc.). These communications devices send and receive data between the vehicle and another transceiver, such as a radio tower, remote from the vehicle. Doppler describes a change of a received signal frequency that happens due to relative movement between a transmitter and a receiver. When there is a relative movement between two ends of a wireless link, like the wireless link between a moving vehicle and a radio tower, Doppler frequency shift is generated, which for a given frequency, is a linear function of the vehicle relative speed.

### SUMMARY

In one exemplary embodiment, a computer-implemented for detecting abrupt deceleration of a vehicle using Doppler change of a received signal may include establishing, by a processing device, a radio link between a transceiver in the vehicle and a remote transceiver. The method may further include continuously calculating, by the processing device, the Doppler of the received signal. Additionally, the method may include detecting, by the processing device, a change in the Doppler of the received signal. Further, the method may include determining, by the processing device, whether the change in the Doppler of the received signal is indicative of a crash.

An example computer-implemented method may further include, responsive to determining that the change in the Doppler of the received signal is indicative of a crash, sending an emergency alert from the transceiver in the vehicle. An example computer-implemented method may further include, responsive to determining that the change in the Doppler of the received signal is not indicative of a crash, continuing to continuously calculate the Doppler of the received signal. In some example computer-implemented methods, detecting the change in the Doppler of the received signal comprises determining a first derivative of the Doppler of the received signal. In some example computer-implemented methods, determining whether the change in the Doppler of the received signal is indicative of a crash further comprises comparing the first derivative of the Doppler of the received signal to pre-determined threshold. In some example computer-implemented methods, the change in the Doppler is indicative of a crash when the first derivative of the Doppler of the received signal exceeds the threshold. Some computer-implemented methods further include detecting an abrupt deceleration form an estimated Doppler coefficient D_{c} which is given by the following equation:

$${D}_{c} = \frac{speed [ \frac{m}{s} ] cos α}{c [ \frac{m}{s} ]} \times f [ GHz ] \times {10}^{9} ,$$

where speed is a speed of the vehicle, α is an angle between a vehicle path and a propagation direction of the received signal, c is a speed of light, and f is a frequency of the radio link. In some example computer-implemented methods, continuously calculating the Doppler of the received signal, further comprises time averaging the estimation of the Doppler.

In another exemplary embodiment a system for detecting abrupt deceleration of a vehicle based on sharp change of Doppler estimation may include a transceiver in the vehicle, wherein the transceiver establishes a radio link between the transceiver in the vehicle and a remote transceiver. The system may further include a Doppler estimation module configured to estimate the Doppler Coefficient of the received signal; calculate a first derivative of the Doppler Coefficient; and determine whether the first derivative of the Doppler Coefficient is indicative of a crash.

In some example systems, an estimated Doppler of the received signal is given by the following equation:

$${D}_{c}^{norm} = \frac{speed [ \frac{m}{s} ] cos α}{c [ \frac{m}{s} ]} \times {10}^{9} ,$$

where

$${D}_{c}^{norm} = \frac{{D}_{c}}{f} ,$$

and speed is a speed of the vehicle, α is an angle between a vehicle path and the received signal propagation direction, and c is a speed of light. In some example systems, calculating the first derivative of the Doppler Coefficient is performed using the following equation:

$$\frac{Δ Doppler}{Δ time} = \frac{\partial Doppler}{\partial time} \approx \frac{{D}_{c} ( {t}_{2} ) - {D}_{c} ( {t}_{1} )}{( {t}_{2} - {t}_{1} )} .$$

where t₂≥t₁.

In some example systems, determining whether the first derivative of the Doppler Coefficient is indicative of a crash further comprises comparing the first derivative of the Doppler Coefficient to a threshold. In some example systems, the first derivative of the Doppler Coefficient is indicative of a crash when the first derivative of the Doppler coefficient exceeds the threshold.

In yet another exemplary embodiment a computer program product for detecting abrupt deceleration of a vehicle using Doppler change of a received signal may include a computer readable storage medium having program instructions embodied therewith, wherein the computer readable storage medium is not a transitory signal per se, the program instructions executable by a processing device to cause the processing device to perform a method. The method may include establishing, by a processing device, a radio link between a transceiver in the vehicle and a remote transceiver. The method may further include continuously calculating, by the processing device, the Doppler of the received signal. Additionally, the method may include detecting, by the processing device, a change in the Doppler of the received signal. Further, the method may include determining, by the processing device, whether the change in the Doppler of the received signal is indicative of a crash.

An example computer-implemented method may further include, responsive to determining that the change in the Doppler of the received signal is indicative of a crash, sending an emergency alert from the transceiver in the vehicle. An example computer-implemented method may further include, responsive to determining that the change in the Doppler of the received signal is not indicative of a crash, continuing to continuously calculate the Doppler of the received signal. In some example computer-implemented methods, detecting the change in the Doppler of the received signal comprises determining a first derivative of the Doppler of the received signal. In some example computer-implemented methods, determining whether the change in the Doppler of the received signal is indicative of a crash further comprises comparing the first derivative of the Doppler of the received signal to pre-determined threshold. In some example computer-implemented methods, the change in the Doppler signal is indicative of a crash when the first derivative of the Doppler of the received signal exceeds the threshold. Some computer-implemented methods further include detecting an abrupt deceleration form an estimated Doppler coefficient D_{c} which is given by the following equation:

$${D}_{c} = \frac{speed [ \frac{m}{s} ] cos α}{c [ \frac{m}{s} ]} \times f [ GHz ] \times {10}^{9} ,$$

where speed is a speed of the vehicle, α is an angle between a vehicle path and a propagation direction of the received signal, c is a speed of light, and f is a frequency of the radio link.

The above features and advantages, and other features and advantages, of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 illustrates an environment for detecting abrupt deceleration of a vehicle using Doppler change of a received signal, according to embodiments of the present disclosure;

FIG. 2 illustrates a block diagram of a processing system for detecting abrupt deceleration of a vehicle using Doppler change of a received signal according to embodiments of the present disclosure;

FIGS. 3A and 3B illustrate graphs respectively of speed over time and Doppler over time according to embodiments of the present disclosure;

FIG. 4 illustrates a graph of the change of Doppler frequency over time according to embodiments of the present disclosure;

FIG. 5A illustrates a graph of a noisy Doppler signal over time according to aspects of the present disclosure;

FIG. 5B illustrates a graph of a time averaged noisy Doppler signal over time according to aspects of the present disclosure;

FIG. 6 illustrates a flow diagram of a method for detecting abrupt deceleration of a vehicle using Doppler change of a received signal according to an exemplary embodiment; and

FIG. 7 illustrates a block diagram of a processing system for implementing the techniques described herein according to an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The technical solutions described herein may include determining a change in Doppler signal and using the change in Doppler of the received signal to detect an abrupt deceleration of a vehicle. For example, a vehicle may be equipped with various wireless communications devices to transmit and receive data using a variety of wireless data communication protocols such as dedicated short-range communications (DSRC), Wi-Fi, cellular, etc. These communications devices send and receive data between the vehicle and another transceiver (referred to as a “remote transceiver”), such as a radio tower, remote from the vehicle.

In existing implementations, a vehicle may include dedicated hardware for detecting an abrupt deceleration of the vehicle. An abrupt deceleration may indicate that the vehicle experienced an accident. For example, if the vehicle collides with another vehicle, a stationary object, or the like, the vehicle may experience a sudden, abrupt deceleration as a result of the collision.

Accordingly, in one embodiment, the technical solutions described herein facilitate collision identification without additional hardware. In particular, the technical solutions disclosed herein provide an additional technique for detecting an abrupt deceleration without additional hardware by determining a change in a Doppler of a received signal between one of the vehicle's communications devices and its associated remote transceiver. In addition, the described technical solutions satisfy Automotive Safety Integrity Level (ASIL) B crash detection requirements.

Generally, Doppler is a function of the relative speed between a transmitter and a receiver and the signal wavelength. The Doppler coefficient is given by the following equation:

$${D}_{c} [ Hz ] = \frac{speed [ \frac{m}{s} ] \times cos α}{wavelength [ m ]} ,$$

where wavelength is a function of frequency f and signal velocity v as follows:

$$wavelength [ m ] = \frac{v}{f} .$$

For electromagnetic signals, moving at the speed of light c, the wavelength can be calculated as follows:

$$wavelength = \frac{c}{f} = \frac{3 x {10}^{8} [ \frac{m}{s} ]}{f} = \frac{3}{10 \times f [ GHz ]} .$$

The normalized Doppler Coefficient (D_{c}^{norm}) is given by:

$${D}_{c}^{norm} = \frac{speed [ \frac{m}{s} ] cos α}{c [ \frac{m}{s} ]} \times {10}^{9} .$$

The normalized Doppler Coefficient is ignorant to the carrier frequency and normalized to GHz. Accordingly,

D_{c}^{norm}=D_{c}/f [GHz].

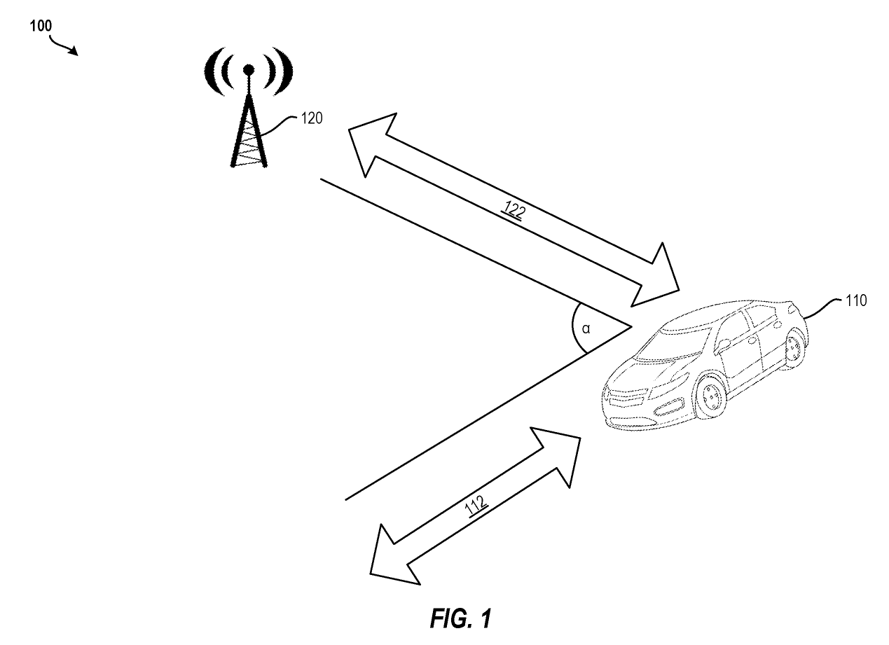

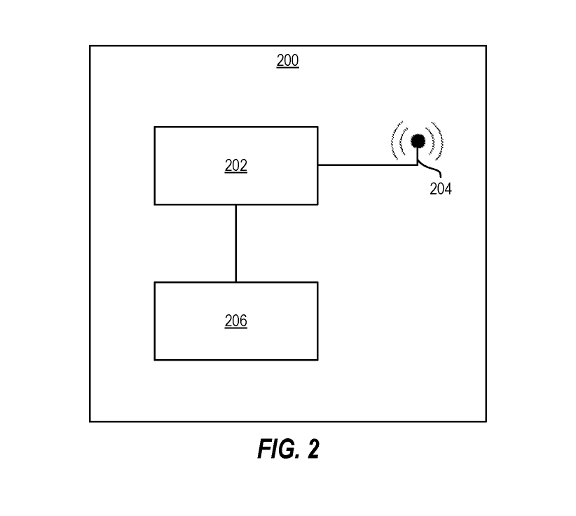

FIG. 1 illustrates an environment 100 for detecting abrupt deceleration of a vehicle 110 using the Doppler of the received signal. In particular, the vehicle 110 may include a processing system 200 of FIG. 2, for detecting the abrupt deceleration of the vehicle 110 using Doppler of the received signal. The processing system 200 may include a transceiver 202, an antenna 204, and a Doppler calculation module 206. The system 200 may be arranged in a vehicle, such as a car, truck, van, bus, motorcycle, boat, plane, or another suitable vehicle. It should be appreciated that, in other embodiments, other numbers of transceivers and/or antennae may be implemented.

In particular, the environment 100 includes a vehicle 110 that is driving along a vehicle path 112 at a particular vehicle speed. The vehicle 100 may include a transceiver 202 and an antenna 204 that establishes a radio link 122 with a remote transceiver 120, which can be any fixed or moving transceiver of any wireless technology (e.g., cellular, WiFi, DSRC, etc.). The radio link 122 enables the vehicle 110 to receive a signal from the remote transceiver 120. As illustrated, the vehicle path 112 is at an angle α with respect to the radio link 122 propagation.

As one possible example, the vehicle 110 is moving at a speed of 90 km/h directly towards the remote transceiver 120 (i.e., α=0) with a transceiver 202 operating at 700 Mhz (0.7 GHz). In this example, the wavelength and Doppler using an estimated Doppler Coefficient as follows:

$$wavelength [ m ] = \frac{c}{f} = \frac{3 * {10}^{8}}{0.7 * {10}^{9}} = \frac{3}{10 * 0.7} = 0.43 m . \\ {D}_{c} = \frac{speed [ \frac{m}{s} ] cos α}{c [ \frac{m}{s} ]} * f [ GHz ] * {10}^{9} = \frac{25}{3 \times {10}^{8}} * 0.7 * {10}^{9} = 58.33 Hz$$

$${D}_{c}^{norm} = \frac{{D}_{c}}{f [ GHz ]} = \frac{58.3}{0.7} = 83.33$$

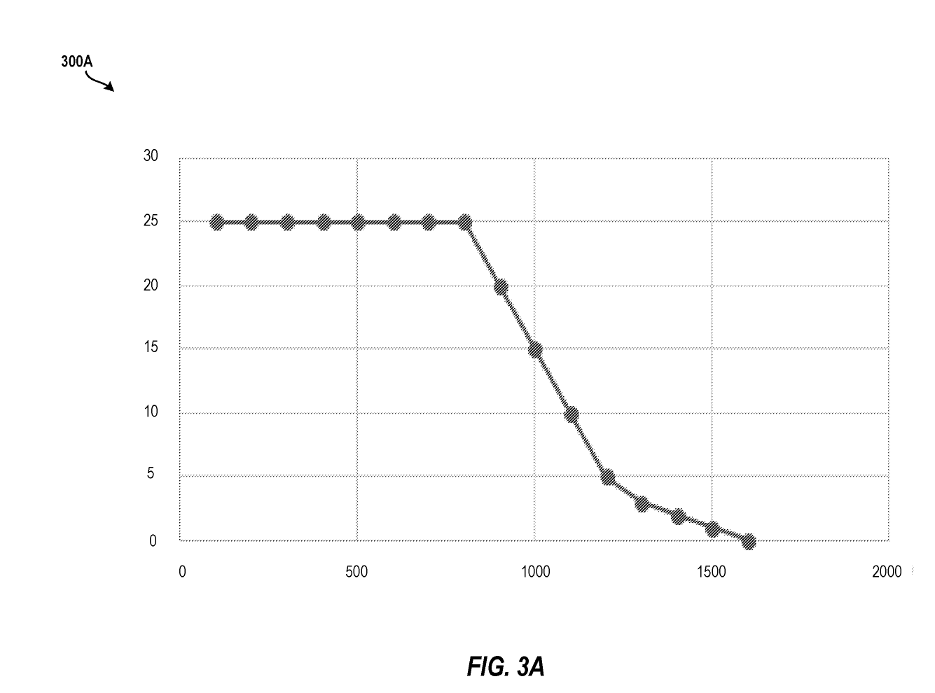

The Doppler calculation module 206 receives from the transceiver module 202 instantaneous Doppler estimation of the received signal of the radio link 122, the Doppler calculation module 206 detects and calculates changes in Doppler to determine when an abrupt deceleration occurs, which may be indicative of a crash. In the case of a crash, the Doppler change is detected. As an example, in the case where the deceleration Δv/Δt is 5 m/s in 100 ms (i.e., a deceleration of 50 m/s²) from 90 km/hr (25 m/s) to ˜0 km/hr, the Doppler Coefficient change (at 0.7 GHz) decreases from 58.33 Hz to close to 9 Hz in 0.5 s. This is illustrated in FIGS. 3A and 3B which illustrate graphs 300A and 300B respectively of speed vs. time and Doppler vs. time. As shown in the graphs 300A and 300B, as the speed decreases over time, the Doppler also decreases over time.

In order to detect a crash, the Doppler calculation module 206 evaluates the Doppler change or the first derivative (with respect to time) of the Doppler Coefficient. For example, the change in Doppler over the change in time is represented as the first derivative of the Doppler with respect to time. Similarly, the change in the Doppler Coefficient over the change in time is represented as the first derivative of the Doppler Coefficient with respect to time. In the above example, the first derivative of the Doppler with respect to time is as follows:

$$- \frac{Δ {D}_{c}}{Δ time} = - \frac{\partial {D}_{c}}{\partial time} \approx - \frac{{D}_{c} ( {t}_{2} ) - {D}_{c} ( {t}_{1} )}{( {t}_{2} - {t}_{1} )} = 116 Hz \text{/} s$$

where t₂≥t₁.

Similarly, the first derivative of the Doppler Coefficient with respect to time is as follows:

$$- \frac{Δ {D}_{c}^{norm}}{Δ time} = - \frac{\partial {D}_{c}^{norm}}{\partial time} = 166.6 .$$

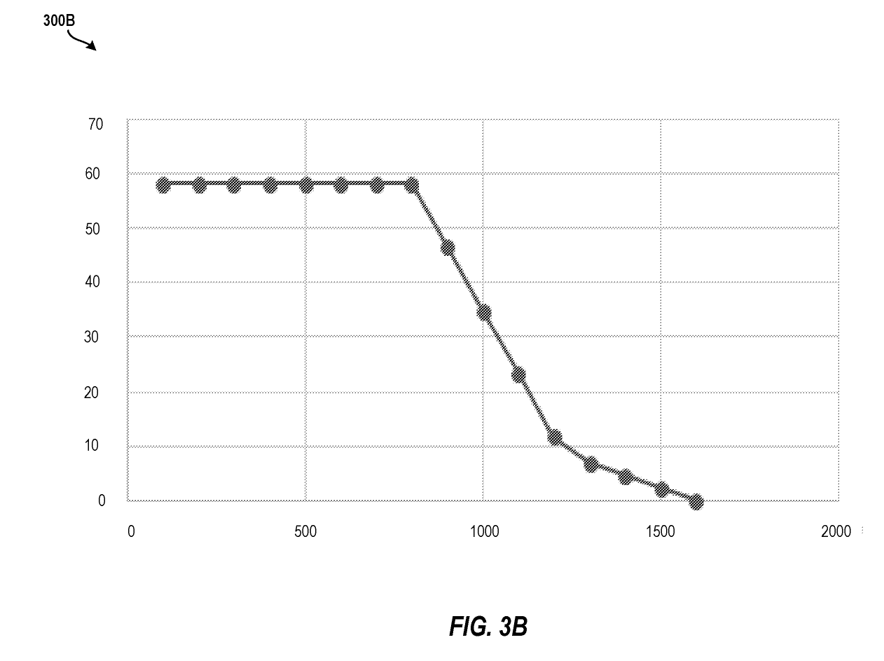

In examples, the Doppler calculation module 206 calculates the first derivative of the Doppler coefficient D_{C} which, for the example describe above, is illustrated in FIG. 4. In particular, FIG. 4 illustrates a graph 400 of the minus of the change of Doppler coefficient over time.

A crash can be indicated by the occurrence of one of two independent conditions. In a first condition, a change in the minus of Doppler coefficient can exceed a threshold, which indicates that a crash occurred. For example, a crash can be indicated by the change in the minus of the Doppler coefficient with respect to time being greater than a threshold. For example, if the threshold is 50 Hz/s, and the minus of the change in Doppler coefficient with respect to time is 116 Hz/s as in the example above, the threshold is exceeded, and the Doppler calculation module 206 determines that a crash occurred.

Similarly, a crash can be indicated by the change of the minus of the normalized Doppler Coefficient with respect to time being greater than a threshold. For example, if the threshold is 100, and the minus of the change in the normalized Doppler Coefficient with respect to time is 166.6 as in the example above, the threshold is exceeded, and the Doppler calculation module 206 determines that a crash occurred.

According to aspects of the present disclosure, the threshold can be a function of frequency carrier, crash profile (i.e., a deceleration curve), criteria for airbag inflation, Doppler signal reliability/estimation quality, and the like. As an additional example, for a vehicle with a transceiver operating at 2 GHz, a priori deceleration lower bound value of 10 m/s² and a good quality Doppler coefficient, the threshold can be 66 Hz/s. It should be appreciated that the threshold for the minus of the Doppler coefficient change and/or the threshold for the normalized Doppler Coefficient change are adjustable.

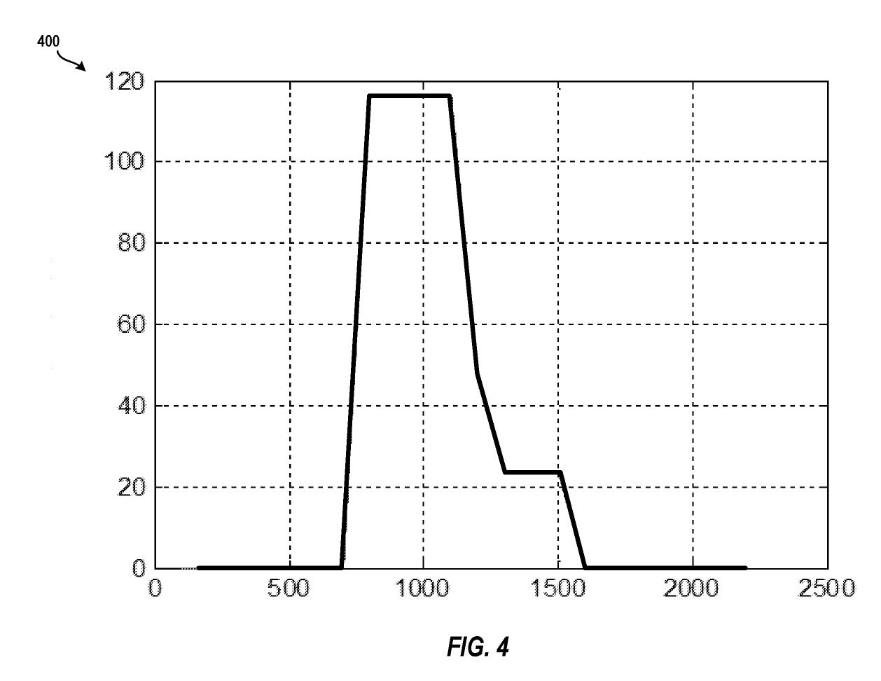

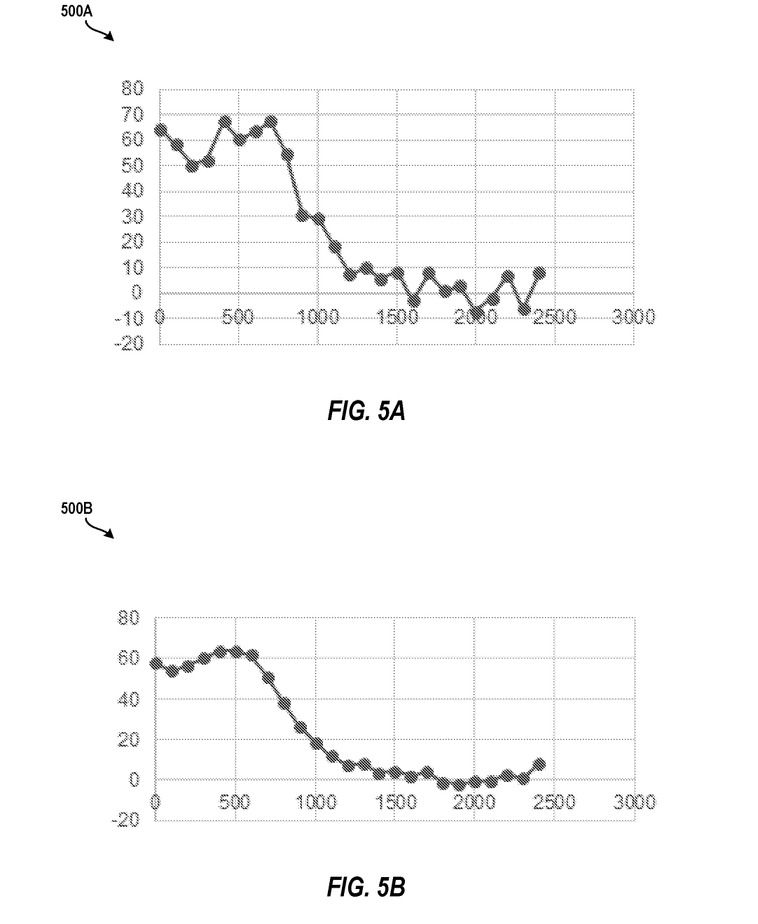

According to some aspects of the present disclosure, averaging the Doppler signal (received in Doppler Calculation module 206 from the transceiver module 202) or the first derivative of Doppler coefficient D_{c} over time may provide a more accurate indication of a crash. For example, in the event that the Doppler signal has material noise, averaging the Doppler signal over time increases reliability. As one such example, FIG. 5A illustrates a graph 500A of a noisy Doppler signal over time, and FIG. 5B illustrates a graph 500B of a time averaged noisy Doppler signal over time according to aspects of the present disclosure. Graph 500B indicates that, even with averaging (i.e., with a longer deceleration estimate time), it can be observed that the vehicle's Doppler changed from 60 Hz to around zero Hz in not more than one second, which is indicative of a crash.

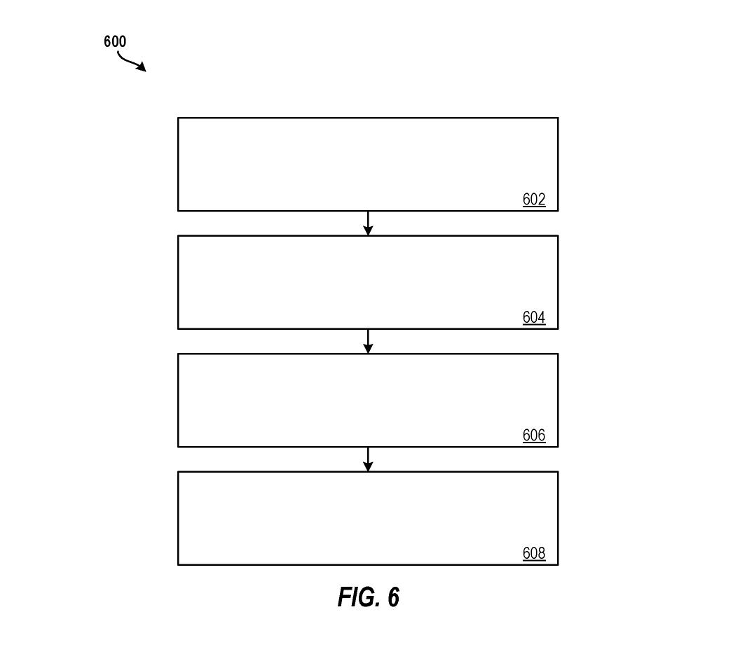

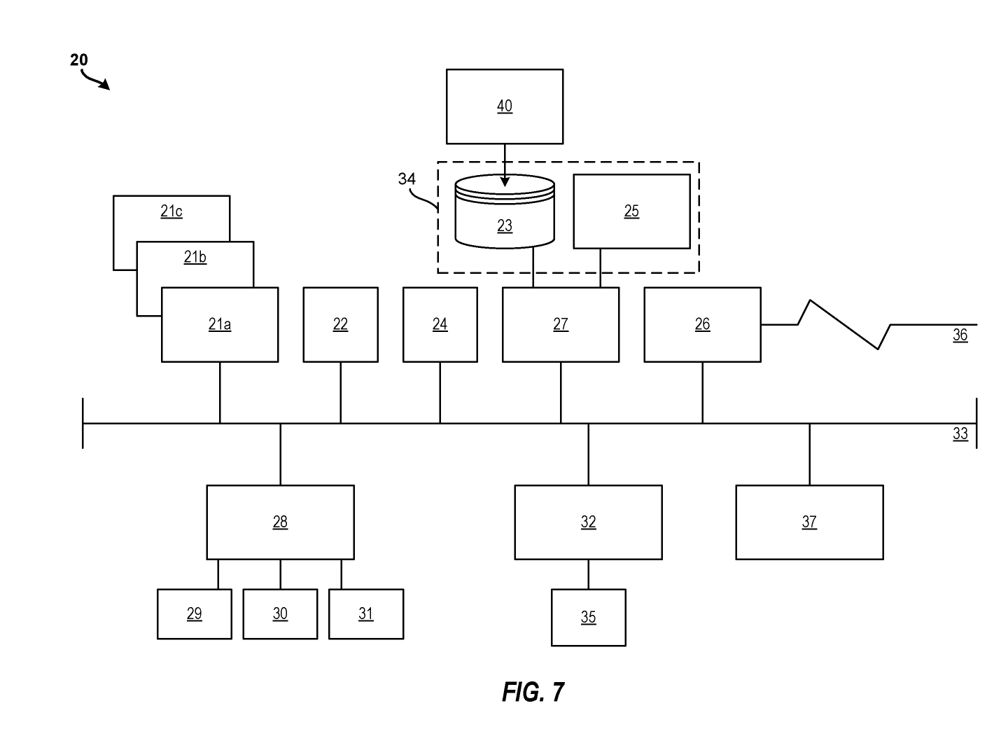

FIG. 6 illustrates a flow diagram of a method for detecting abrupt deceleration of a vehicle using Doppler change of a received signal according to an exemplary embodiment. The method 600 may be implemented, for example, by the Doppler change calculation module of the processing system 200 of FIG. 2, by the processing system 20 of FIG. 7, or by another suitable processing system or device.

At block 602, the method 600 includes establishing a radio link between a transceiver in the vehicle and a remote transceiver. At block 604, the method 600 includes continuously calculating a Doppler of the received signal.

At block 606, the method 600 includes detecting a change in the Doppler of the received signal. In some examples, detecting the change in the Doppler of the received signal includes determining a first derivative of the Doppler of the received signal.

At block 608, the method 600 includes determining whether the change in the Doppler of the received signal is indicative of an abrupt deceleration (i.e., a crash). In some examples, determining whether the change in the Doppler of the received signal is indicative of a crash further includes comparing the first derivative of the Doppler of the received signal to a threshold. A crash may be indicated when the minus of the first derivative of the Doppler of the received signal exceeds the threshold.

In some examples, the method 600 may further include sending an emergency alert from the transceiver in the vehicle responsive to determining that the change in the Doppler of the received signal is indicative of a crash. However, it should be appreciated that another transceiver may be used to send the emergency alert. If no crash is detected, the method 600 may continue to calculate a Doppler signal (such as when the vehicle changes position, speed, orientation, etc.).

Additional processes also may be included, and it should be understood that the processes depicted in FIG. 6 represent illustrations, and that other processes may be added or existing processes may be removed, modified, or rearranged without departing from the scope and spirit of the present disclosure.

It is understood that the present disclosure is capable of being implemented in conjunction with any other type of computing environment now known or later developed. For example, FIG. 7 illustrates a block diagram of a processing system 20 for implementing the techniques described herein. In examples, processing system 20 has one or more central processing units (processors) 21a, 21b, 21c, etc. (collectively or generically referred to as processor(s) 21 and/or as processing device(s)). In aspects of the present disclosure, each processor 21 may include a reduced instruction set computer (RISC) microprocessor. Processors 21 are coupled to system memory (e.g., random access memory (RAM) 24) and various other components via a system bus 33. Read only memory (ROM) 22 is coupled to system bus 33 and may include a basic input/output system (BIOS), which controls certain basic functions of processing system 20.

Further illustrated are an input/output (I/O) adapter 27 and a communications adapter 26 coupled to system bus 33. I/O adapter 27 may be a small computer system interface (SCSI) adapter that communicates with a hard disk 23 and/or a tape storage drive 25 or any other similar component. I/O adapter 27, hard disk 23, and tape storage device 25 are collectively referred to herein as mass storage 34. Operating system 40 for execution on processing system 20 may be stored in mass storage 34. A network adapter 26 interconnects system bus 33 with an outside network 36 enabling processing system 20 to communicate with other such systems.

A display (e.g., a monitor) 35 is connected to system bus 33 by display adaptor 32, which may include a graphics adapter to improve the performance of graphics intensive applications and a video controller. In one aspect of the present disclosure, adapters 26, 27, and/or 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 may be interconnected to system bus 33 via user interface adapter 28, which may include, for example, a Super I/O chip integrating multiple device adapters into a single integrated circuit.

In some aspects of the present disclosure, processing system 20 includes a graphics processing unit 37. Graphics processing unit 37 is a specialized electronic circuit designed to manipulate and alter memory to accelerate the creation of images in a frame buffer intended for output to a display. In general, graphics processing unit 37 is very efficient at manipulating computer graphics and image processing, and has a highly parallel structure that makes it more effective than general-purpose CPUs for algorithms where processing of large blocks of data is done in parallel.

Thus, as configured herein, processing system 20 includes processing capability in the form of processors 21, storage capability including system memory (e.g., RAM 24), and mass storage 34, input means such as keyboard 29 and mouse 30, and output capability including speaker 31 and display 35. In some aspects of the present disclosure, a portion of system memory (e.g., RAM 24) and mass storage 34 collectively store an operating system to coordinate the functions of the various components shown in processing system 20.

The present techniques may be implemented as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to aspects of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various examples of the present disclosure have been presented for purposes of illustration, but are not intended to be exhaustive or limited to the embodiments disclosed. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques disclosed herein.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present techniques not be limited to the particular embodiments disclosed, but will include all embodiments falling within the scope of the application.

What is claimed is:

1. A computer-implemented method for detecting abrupt deceleration of a vehicle using Doppler change of a received signal, the method comprising:
establishing, by a processing device, a radio link between a transceiver in the vehicle and a remote transceiver;
continuously calculating, by the processing device, a Doppler of the received signal;
detecting, by the processing device, a change in the Doppler of the received signal; and
determining, by the processing device, whether the change in the Doppler of the received signal is indicative of an abrupt deceleration.

2. The computer-implemented method of claim 1, further comprising:
responsive to determining that the change in the Doppler of the received signal is indicative of an abrupt deceleration, sending an emergency alert from the transceiver in the vehicle.

3. The computer-implemented method of claim 1, further comprising:
responsive to determining that the change in the Doppler of the received signal is not indicative of an abrupt deceleration, continuing to continuously calculate the Doppler of the received signal.

4. The computer-implemented method of claim 1, wherein detecting the change in the Doppler of the received signal comprises determining a first derivative of the Doppler of the received signal.

5. The computer-implemented method of claim 4, wherein determining whether the change in the Doppler of the received signal is indicative of an abrupt deceleration further comprises comparing the first derivative of the Doppler of the received signal to a threshold.

6. The computer-implemented method of claim 5, wherein the change in the Doppler is indicative of an abrupt deceleration when the first derivative of the Doppler of the received signal exceeds the threshold.

7. The computer-implemented method of claim 1, further comprising detecting an abrupt deceleration from an estimated Doppler coefficient D_{c} which is given by the following equation:
$${D}_{c} = \frac{speed [ \frac{m}{s} ] cos α}{c [ \frac{m}{s} ]} \times f [ GHz ] * {10}^{9} ,$$
where speed is a speed of the vehicle, α is an angle between a vehicle path and a propagation direction of the received signal, c is a speed of light, and f is a frequency of the radio link.

8. The computer-implemented method of claim 1, wherein continuously calculating the Doppler of the received signal further comprises time averaging the Doppler.

9. A system for detecting abrupt deceleration of a vehicle based on an abrupt change of Doppler estimation for a received signal, the system comprising:
a transceiver in the vehicle, wherein the transceiver establishes a radio link between the transceiver in the vehicle and a remote transceiver; and
a Doppler estimation module configured to:
estimate a Doppler Coefficient of a Doppler of the received signal;
calculate a first derivative of the Doppler Coefficient; and
determine whether the first derivative of the Doppler Coefficient of the radio link is indicative of an abrupt deceleration.

10. The system of claim 9, wherein calculating the Doppler of the received signal is given by the following equation:
$${D}_{c}^{norm} = \frac{speed [ \frac{m}{s} ] cos α}{c [ \frac{m}{s} ]} \times {10}^{9} ,$$
where
$${D}_{c}^{norm} = \frac{{D}_{c}}{f} ,$$
speed is a speed of the vehicle, α is an angle between a vehicle path and a propagation direction of the received signal, and c is a speed of light.

11. The system of claim 9, wherein calculating the first derivative of the Doppler Coefficient is performed using the following equation:
$$\frac{Δ Doppler}{Δ time} = \frac{\partial Doppler}{\partial time} \approx \frac{{D}_{c} ( {t}_{2} ) - {D}_{c} ( {t}_{1} )}{( {t}_{2} - {t}_{1} )} .$$
where t₂≥t₁.

12. The system of claim 9, wherein determining whether the first derivative of the Doppler Coefficient is indicative of an abrupt deceleration further comprises comparing the minus of the first derivative of the Doppler Coefficient to a threshold.

13. The system of claim 12, wherein the first derivative of the Doppler Coefficient is indicative of an abrupt deceleration when the minus of the first derivative of the Doppler of the received signal exceeds the threshold.

14. A computer program product for detecting abrupt deceleration of a vehicle using Doppler change of a received signal, the computer program product comprising:
a computer readable storage medium having program instructions embodied therewith, wherein the computer readable storage medium is not a transitory signal per se, the program instructions executable by a processing device to cause the processing device to perform a method comprising:
establishing, by the processing device, a radio link between a transceiver in the vehicle and a remote transceiver;
continuously calculating, by the processing device, a Doppler of the received signal;
detecting, by the processing device, a change in the Doppler of the received signal; and
determining, by the processing device, whether the change in the Doppler of the received signal is indicative of an abrupt deceleration.

15. The computer program product of claim 14, the method further comprising:
responsive to determining that the change in the Doppler of the received signal is indicative of an abrupt deceleration, sending an emergency alert from the transceiver in the vehicle.

16. The computer program product of claim 14, the method further comprising:
responsive to determining that the change in the Doppler of the received signal is not indicative of an abrupt deceleration, continuing to continuously calculate the Doppler of the received signal.

17. The computer program product of claim 14, wherein detecting the change in the Doppler of the received signal comprises determining a first derivative of the Doppler of the received signal.

18. The computer program product of claim 17, wherein determining whether the change in the Doppler of the received signal is indicative of an abrupt deceleration further comprises comparing the first derivative of the Doppler of the received signal to a threshold.

19. The computer program product of claim 18, wherein the change in the Doppler signal is indicative of an abrupt deceleration when the first derivative of the Doppler of the received signal exceeds the threshold.

20. The computer program product of claim 14, the method further comprising detecting an abrupt deceleration form an estimated Doppler coefficient D_{c} which is given by the following equation:
$${D}_{c} = \frac{speed [ \frac{m}{s} ] cos α}{c [ \frac{m}{s} ]} \times f [ GHz ] \times {10}^{9} ,$$
where speed is a speed of the vehicle, α is an angle between a vehicle path and a propagation direction of the received signal, c is a speed of light, and f is a frequency of the radio link.
